(19) United States
(12) Patent Application Publication
(10) Pub. No.: US 2020/0184033 A1
(43) Pub. Date: Jun. 11, 2020

(54) SIMULATION APPARATUS OF POWER SUPPLY DEVICE

(71) Applicant: FUJITSU LIMITED, Kawasaki-shi (JP)

(72) Inventors: Yu Yonezawa, Sagamihara (JP); YOSHIYASU NAKASHIMA, Kawasaki (JP)

(73) Assignee: FUJITSU LIMITED, Kawasaki-shi (JP)

(21) Appl. No.: 16/674,787

(22) Filed: Nov. 5, 2019

(30) Foreign Application Priority Data
Dec. 11, 2018 (JP) 2018-231977

(51) Int. Cl. G06F 17/50; H02M 3/156

(52) U.S. Cl. CPC G06F 17/5036; H02M 3/156

(57) ABSTRACT

A simulation apparatus of a power supply circuit includes an input processing circuit configured to process a pulse signal output from a control device that controls the power supply circuit, a memory, a processor coupled to the memory and configured to derive a response signal with respect to the pulse signal processed by the input processing circuit, by a calculation using a plurality of transfer functions that represents characteristics of the power supply circuit, and process the response signal to transmit to a device that displays the response signal, and an output processing circuit configured to process the response signal to transmit to the control device.

### CROSS-REFERENCE TO RELATED APPLICATION

This application is based upon and claims the benefit of the prior Japanese Patent Application No. 2018-231977, filed on Dec. 11, 2018, the entire contents of which are incorporated herein by reference.

### FIELD

The embodiments discussed herein are related to a simulation apparatus of a power supply device.

### BACKGROUND

As a technique of testing a target device to be tested, following techniques have been known. For example, there is known a testing device including: a test unit that supplies a predetermined test pattern to a target device to be tested; and a main power supply that performs a feedback control on an output voltage such that a detection value corresponding to a power-supply voltage of the target device approaches a target value. The testing device includes a power supply controller that performs a feed-forward control on the main power supply such that the power-supply voltage of the target device approaches a predetermined target waveform, when the test unit supplies the test pattern to the target device.

In addition, a simulation apparatus that simulates a control target that is controlled by a control device is known. The simulation apparatus includes: a model calculation unit that repeatedly executes a model calculation for simulating the control target and calculating a state value of the control target, at a predetermined model calculation period; and a signal output unit that outputs a signal value based on the state value calculated by the model calculation unit, to the control device. Further, the simulation apparatus includes a state value correction unit that corrects the state value on the basis of a past state value until the state value is updated by the model calculation unit. The signal output unit outputs a signal value based on the corrected state value calculated by the state value correction unit, to the control device.

A power supply device that supplies an output voltage to a load device is known. The power supply device includes a power supply circuit that includes a switching unit configured to perform switching at a predetermined frequency, and generates an output voltage. Further, the power supply device includes a phase compensator that performs a feedback control on a switching duty of the switching unit on the basis of the output voltage of the power supply circuit, and at the same time, varies a response characteristic of the output voltage to a load fluctuation of the load device on the basis of a reference voltage and the output voltage of the power supply circuit. Further, the power supply device includes a controller that adds a pilot signal over a predetermined frequency range to the reference voltage, and at the same time, monitors the output voltage from the power supply circuit so as to control the response characteristic on the basis of the pilot signal and the output voltage.

Related techniques are disclosed in, for example, Japanese Laid-open Patent Publication Nos. 2013-181831, 2010-218328, and 2017-038482.

### SUMMARY

According to an aspect of the embodiments, a simulation apparatus of a power supply circuit includes an input processing circuit configured to process a pulse signal output from a control device that controls the power supply circuit, a memory, a processor coupled to the memory and configured to derive a response signal with respect to the pulse signal processed by the input processing circuit, by a calculation using a plurality of transfer functions that represents characteristics of the power supply circuit, and process the response signal to transmit to a device that displays the response signal, and an output processing circuit configured to process the response signal to transmit to the control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of a functional configuration of a simulation apparatus of a power supply device according to an embodiment of the present disclosure;

FIGS. 2A and 2B are block diagrams illustrating an example of a hardware configuration of the simulation apparatus and a control MCU according to the embodiment of the present disclosure;

FIG. 3 is a circuit diagram illustrating an example of a configuration of a power supply circuit according to the embodiment of the present disclosure;

FIG. 4 is a view illustrating transfer functions indicating characteristics of the power supply circuit according to the embodiment of the present disclosure;

FIG. 5 is a functional block diagram illustrating an example of a specific functional configuration of a calculation unit according to the embodiment of the present disclosure;

FIG. 6 is a flowchart illustrating an example of the flow of a transfer function derivation process according to the embodiment of the present disclosure;

FIG. 7 is a flowchart illustrating an example of the flow of an arithmetic processing according to the embodiment of the present disclosure;

FIG. 8 is a flowchart illustrating an example of the flow of a data transmission process according to the embodiment of the present disclosure;

FIG. 9 is a flowchart illustrating an example of the flow of a display control process according to the embodiment of the present disclosure;

FIG. 10 is a timing chart illustrating a cooperation of processes in a calculation MCU, a data transmission MCU, and an interface PC according to the embodiment of the present disclosure;

FIGS. 11A and 11B are views illustrating an example of a hardware configuration of a simulation apparatus according to another embodiment of the present disclosure;

FIG. 12 is a flowchart illustrating an example of a transfer function derivation process according to another embodiment of the present disclosure;

FIG. 13 is a functional block diagram illustrating an example of a functional configuration of a calculation unit according to another embodiment of the present disclosure;

FIG. 14 is a flowchart illustrating an example of the flow of an arithmetic processing according to another embodiment of the present disclosure;

FIG. 15A is a view illustrating output voltage waveforms acquired in the simulation apparatus according to the embodiment of the present disclosure and an actual power supply circuit;

FIG. 15B is a view illustrating output voltage waveforms acquired in the simulation apparatus according to the embodiment of the present disclosure and the actual power supply circuit; and

FIG. 15C is a view illustrating output voltage waveforms acquired in the simulation apparatus according to the embodiment of the present disclosure and the actual power supply circuit.

### DESCRIPTION OF EMBODIMENTS

A switching power supply device controls an output voltage output from an output terminal by turning ON/OFF a semiconductor switch provided between an input terminal and the output terminal. As a control method of the switching power supply device, a digital control method is known in which the ON/OFF control of the semiconductor switch is performed by using a micro controller unit (MCU).

Attempts have been made to apply a model-based development as a conventional development technique for the switching power supply device using the digital control method. The model-based development is a technique of expressing control logic specifications in an executable graphical model, and performing a step-by-step verification from a design⋅simulation on a computer to an actual machine test so as to advance a development.

The model-based development includes a plurality of processes such as the Model In the Loop Simulation (MILS), Rapid Control Prototyping (RCP), Production Code Generation (PCG), Hardware In the Loop Simulation (HILS), and an actual machine test. The MILS is a process of checking the behavior of a closed loop system by combining a graphical model representing a control logic with a graphical model representing a circuit as a control target, on a general-purpose computer. The RCP is a process of controlling an actual circuit by the control logic verified by the MILS and verifying whether the control logic is also effective for the actual circuit, by using a dedicated high-performance computer that faithfully reproduces the graphical model representing the control logic. The PCG is a process of automatically generating software (code) to be incorporated into a control MCU used in mass-produced products on the basis of the graphical model representing the control logic verified by the RCP. The NILS is a process of reproducing the circuit as the control target on the computer, and constructing an environment where the circuit on the computer and the control MCU operate in real time interlocking with each other, so as to verify whether the control MCU normally operates. According to the verification by the HILS, even when there is an error in a control algorithm incorporated in the control MCU, it is possible to perform debugging without destroying the circuit as the control target.

However, it is not easy to simulate a power supply circuit model of the switching power supply device in real time. That is, a matrix of a circuit equation of a power supply circuit with, for example, 10 nodes is 10×10. Further, in a circuit simulation, in order to converge the value of the equation, in general, calculation is performed 100 or more times for one node. Therefore, at least 10,000 calculations are required for each step. It is desirable that the 10,000 calculations to be performed for each step are performed with a resolution of about 10 ns. In this case, the number of calculations for one second reaches 10¹² times. In addition, for calculations performed in the circuit simulation, the effect of speeding-up by parallel calculations is hardly obtained, and even when a central processing unit (CPU) is added, it is difficult to reduce the calculation time. Thus, in the conventional HILS environment, it is difficult to simulate the power supply circuit model of the switching power supply device in real time.

Hereinafter, descriptions will be made on an example of an embodiment of a technology that enables real-time simulation of a power supply device by reducing a calculation amount, as compared to the related art, with reference to the accompanying drawings. In the drawings, the same or equivalent components and portions are denoted by the same reference numerals.

### First Embodiment

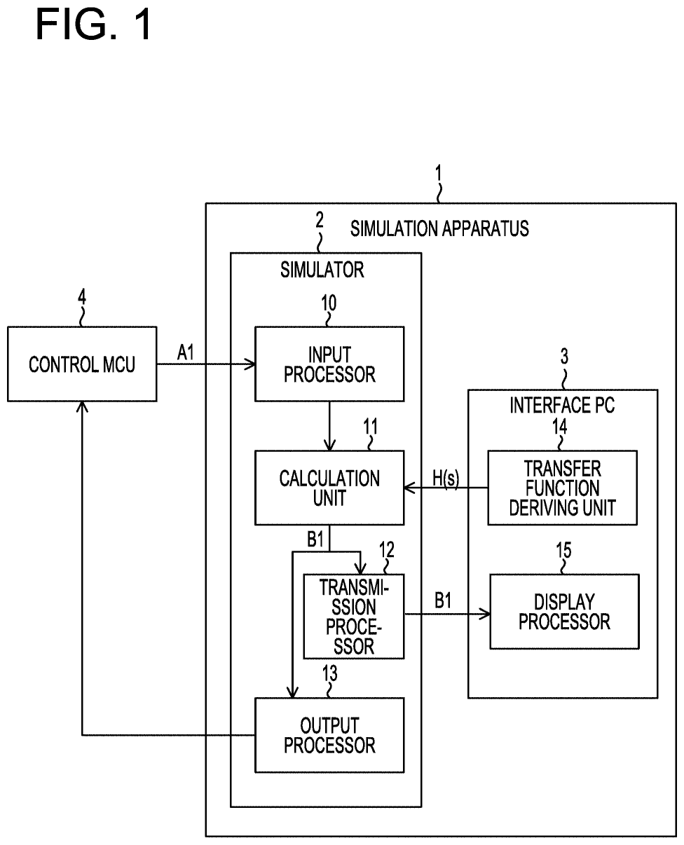

FIG. 1 is a functional block diagram illustrating an example of a functional configuration of a simulation apparatus 1 of a power supply device according to an embodiment of the present disclosure.

The simulation apparatus 1 includes: a simulator 2 that reproduces a power supply circuit portion of the power supply device including a power supply circuit and a control MCU 4; and an interface personal computer (PC) 3 that is connected to the simulator 2 in a communication-available manner. In the control MCU 4, a control logic that controls the power supply circuit reproduced by the simulator 2 is mounted.

The simulation apparatus 1 may be used in the HILS process of the model-based development of the power supply device. That is, when the control MCU 4 is connected to the simulator 2 that reproduces the power supply circuit as a control target, an environment where the control MCU 4 and the simulator 2 operate in real time interlocking with each other is constructed. Accordingly, it is possible to verify whether the control MCU 4 normally operates.

The simulator 2 includes an input processor 10, a calculation unit 11, a transmission processor 12, and an output processor 13. The input processor 10 performs a predetermined processing on a pulse width modulation (PWM) signal A1 that is a control signal output from the control MCU 4. Details of the contents of the processing performed in the input processor 10 will be described later. An output voltage of the power supply circuit reproduced by the simulator 2 is controlled at a level corresponding to the duty of the PWM signal A1.

The calculation unit 11 derives a response output B1 to the PWM signal A1 processed by the input processor 10, by a calculation using a plurality of transfer functions H(s) indicating the characteristics of the power supply circuit. The response output B1 derived by the calculation unit 11 corresponds to the output voltage of the power supply circuit reproduced by the simulator 2. The plurality of transfer functions H(s) indicating the characteristics of the power supply circuit is supplied from the interface PC 3. Details of the arithmetic processing using the plurality of transfer functions H(s) will be described later.

The transmission processor 12 performs a processing of transmitting data of the response output B1 derived by the calculation unit 11 to the interface PC 3.

The output processor 13 performs a predetermined processing on the response output B1 derived by the calculation unit 11 and sends a feedback to the control MCU 4. Details of the contents of the processing performed in the output processor 13 will be described later.

The interface PC 3 functions as a display processor 15 that performs a processing of displaying the response output B1 derived by the calculation unit 11 on a display screen. The display processor 15 displays time transition of the response output B1 derived by the calculation unit 11, that is, an output voltage waveform as time transition of the output voltage of the power supply circuit reproduced by the simulator 2, on the display screen of a display device included in the interface PC 3.

Further, the interface PC 3 functions as a transfer function deriving unit 14 that derives a plurality of transfer functions to be used in the calculation unit 11. The transfer function deriving unit 14 performs circuit simulation on the power supply circuit, and analyzes input/output characteristics of the corresponding power supply circuit so as to derive the plurality of transfer functions H(s) indicating the characteristics of the corresponding power supply circuit. The plurality of transfer functions H(s) derived by the transfer function deriving unit 14 are transmitted to the simulator 2 before the calculation unit 11 performs the arithmetic processing for deriving the response output B1.

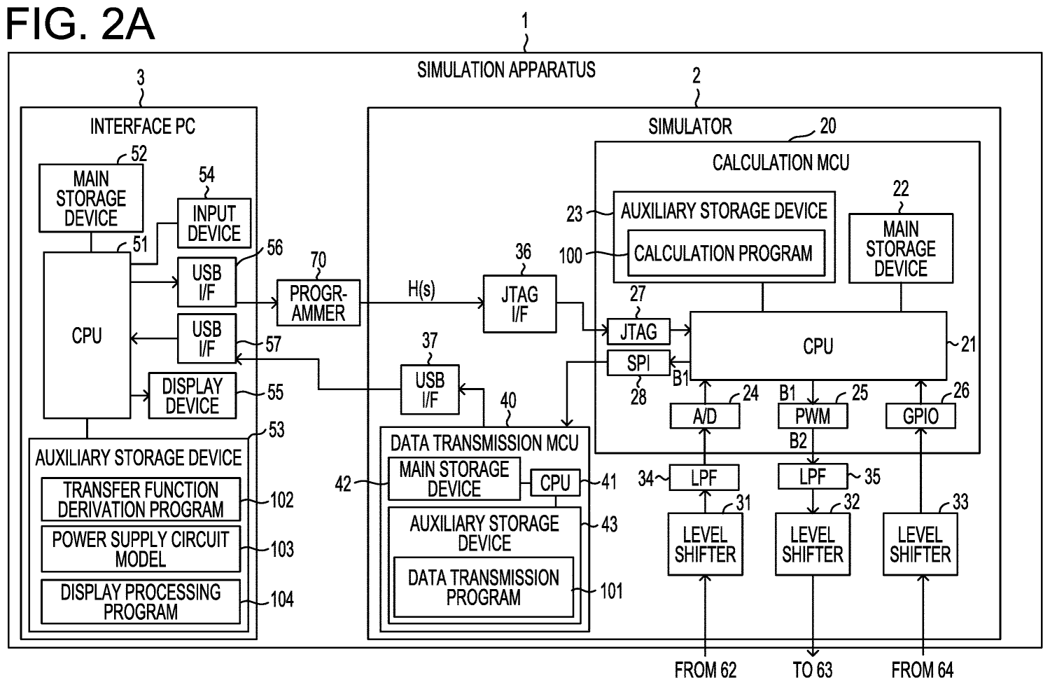

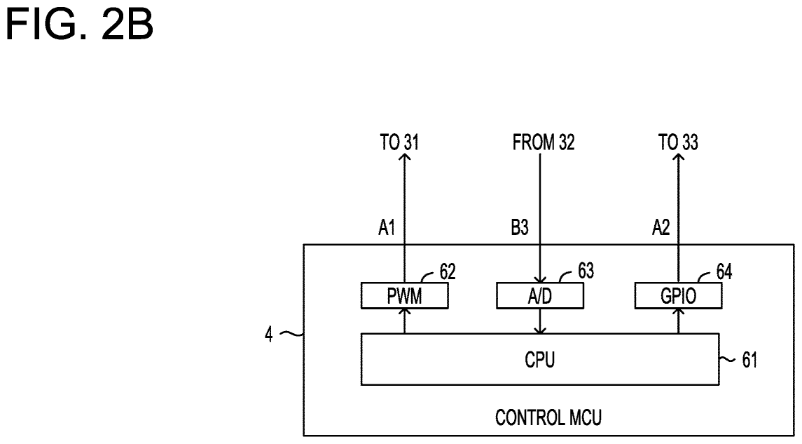

FIGS. 2A and 2B are block diagrams illustrating an example of a hardware configuration of the simulation apparatus 1 and the control MCU 4.

The control MCU 4 includes a CPU 61, a PWM signal generating circuit 62, an analog digital converter 63, and a general-purpose input/output (GPIO) 64. The CPU 61 performs an arithmetic processing for controlling the output voltage of the power supply circuit by a feedback control. The PWM signal generating circuit 62 generates a PWM signal A1 having a duty corresponding to a duty command value supplied from the CPU 61. The analog digital converter 63 converts a response signal B3 that is supplied from the simulator 2 and corresponds to the response output to the PWM signal A1, into a digital signal, and supplies the digital signal to the CPU 61. The CPU 61 updates the duty command value to be supplied to the PWM signal generating circuit 62 on the basis of the digital signal supplied from the analog digital converter 63. The GPIO 64 outputs an ON/OFF switching signal A2 for controlling the ON/OFF of the output voltage in the power supply circuit on the basis of an ON/OFF command value supplied from the CPU 61.

The simulator 2 includes a calculation MCU 20 and peripheral circuits. The calculation MCU 20 includes a CPU 21, a main storage device 22, an auxiliary storage device 23, an analog digital converter 24, a PWM signal generating circuit 25, a GPIO 26, a joint test action group (JTAG) port 27, and a serial peripheral interface (SPI) 28. The peripheral circuits include level shifters 31, 32, and 33, low pass filters 34 and 35, a JTAG interface 36, a data transmission MCU 40, and a USB interface 37.

The level shifter 31 shifts the level of the PWM signal A1 supplied from the control MCU 4, to a level suitable for the calculation MCU 20. The low pass filter 34 averages the level-shifted PWM signal A1. That is, the low pass filter 34 converts the duty of the PWM signal A1 into a voltage level.

The analog digital converter 24 converts the signal supplied from the low pass filter 34 into a digital signal, and supplies the digital signal to the CPU 21. The level shifter 31, the low pass filter 34, and the analog digital converter 24 constitute the input processor 10 (see FIG. 1).

The auxiliary storage device 23 is constituted by a non-volatile storage device such as a hard disk drive (HDD), a solid state drive (SSD), or a flash memory. The auxiliary storage device 23 stores a calculation program 100 that causes the CPU 21 to function as the calculation unit 11. For example, when the digital signal corresponding to the PWM signal A1 supplied from the control MCU 4 is received, the CPU 21 reads the calculation program 100 from the auxiliary storage device 23, deploys the calculation program 100 on the main storage device 22, and sequentially executes processings described in the calculation program 100.

By executing the calculation program 100, the CPU 21 derives a response output B1 to the digital signal that is supplied from the analog digital converter 24 and corresponds to the PWM signal A1, by a calculation using a plurality of transfer functions H(s) indicating characteristics of the power supply circuit. The CPU 21 derives the output voltage of the power supply circuit which is expressed by the plurality of transfer functions H(s), as the response output B1.

The plurality of transfer functions H(s) used for an arithmetic processing in the CPU 21 are generated by the interface PC 3 and transmitted to the simulator 2 via a programmer 70. The plurality of transfer functions H are supplied to the CPU 21 via the JTAG interface 36 and the JTAG port 27. The response output B1 derived by the arithmetic processing in the CPU 21 is supplied to the SPI 28 and the PWM signal generating circuit 25.

The SPI 28 supplies the response output B1 derived by the CPU 21, as serial data, to the data transmission MCU 40.

The data transmission MCU 40 includes a CPU 41, a main storage device 42, and an auxiliary storage device 43. The auxiliary storage device 43 is constituted by a non-volatile storage device such as a HDD, a SSD, or a flash memory. The auxiliary storage device 43 stores a data transmission program 101 that causes the CPU 41 to function as the transmission processor 12 (see FIG. 1). For example, when the response output B1 derived by the calculation MCU 20 is received, the CPU 41 reads the data transmission program 101 from the auxiliary storage device 43, deploys the data transmission program 101 on the main storage device 42, and sequentially executes processings described in the data transmission program 101. By executing the data transmission program 101, the CPU 40 performs a processing of transmitting the response output B1 derived by the calculation MCU 20, to the interface PC 3 via the USB interface 37.

The PWM signal generating circuit 25 generates a PWM signal B2 having a duty corresponding to the output voltage as the response output B1 derived by the CPU 21. The low pass filter 35 averages the PWM signal B2. That is, the low pass filter 35 converts the duty of the PWM signal B2 into a voltage level.

The level shifter 32 shifts the level of the signal supplied from the low pass filter 35 to a level suitable for the control MCU 4, and supplies the signal with the shifted level as the response signal B3 to the control MCU 4. The PWM signal generating circuit 25, the low pass filter 35, and the level shifter 32 constitute the output processor 13 (see, e.g., FIG. 1).

A feedback loop is formed between the control MCU 4 and the calculation MCU 20 so that a feedback control is performed on the output voltage as the response output B1 derived by the CPU 21 of the calculation MCU 20.

The level shifter 33 shifts the level of the ON/OFF switching signal A2 supplied from the control MCU 4, to a level suitable for the calculation MCU 20. The ON/OFF switching signal A2 is supplied to the CPU 21 of the calculation MCU 20, via the GPIO 26. The CPU 21 sends the response output B2 on the basis of the ON/OFF switching signal A2.

The interface PC 3 includes a CPU 51, a main storage device 52, an auxiliary storage device 53, an input device 54, a display device 55, and USB interfaces 56 and 57.

The input device 54 includes, for example, a keyboard and a mouse. The display device 55 includes, for example, a liquid crystal display.

The auxiliary storage device 53 is constituted by a non-volatile storage device such as an HDD, a SSD, or a flash memory. The auxiliary storage device 53 stores a transfer function derivation program 102 that causes the CPU 51 to function as the transfer function deriving unit 14 (see FIG. 1) and a power supply circuit model 103. Further, the auxiliary storage device 53 stores a display processing program 104 that causes the CPU 51 to function as the display processor 15 (see FIG. 1).

For example, when an input operation to instruct a derivation of transfer functions H(s) is performed on the input device 54, the CPU 51 reads the transfer function derivation program 102 from the auxiliary storage device 53, deploys the transfer function derivation program 102 on the main storage device 52, and sequentially executes processings described in the transfer function derivation program 102. By executing the transfer function derivation program 102, the CPU 51 derives the plurality of transfer functions H(s) to be used in the arithmetic processing in the CPU 21 of the calculation MCU 20. The CPU 51 performs a circuit simulation using the power supply circuit model 103 stored in the auxiliary storage device 53, and analyzes input/output characteristics of the corresponding power supply circuit, so as to derive the plurality of transfer functions H(s) indicating the characteristics of the corresponding power supply circuit. The plurality of transfer functions H(s) derived by the CPU 51 are transmitted to the simulator 2 via the USB interface 56 and the programmer 70.

Meanwhile, the data of the response output B1 that is derived by the calculation MCU 20 and is transmitted by the data transmission MCU 40 is supplied to the CPU 51 via the USB interface 57. For example, when the response output B1 is received, the CPU 51 reads the display processing program 104 from the auxiliary storage device 53, deploys the display processing program 104 on the main storage device 52, and sequentially executes processings described in the display processing program 104. By executing the display processing program 104, the CPU 51 displays time transition of the output voltage as the response output B1 derived by the calculation MCU 20, that is, an output voltage waveform, on a display screen of the display device 55. In addition, the hardware for implementing the function of the display processor 15 may be configured to be integrated with the simulator 2, or may be configured separately from the simulator 2. For example, by executing the display processing program 104, the data transmission MCU 40 may transmit the data indicating the output voltage waveform to the display device 55 of the interface PC 3.

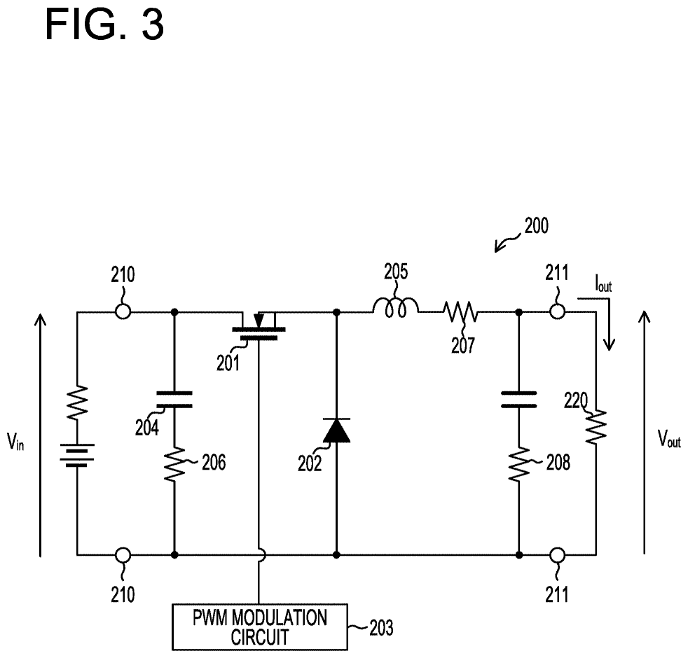

FIG. 3 is a circuit diagram illustrating an example of a configuration of a power supply circuit 200 expressed by a plurality of transfer functions H(s) used for an arithmetic processing in the CPU 21 of the calculation MCU 20. As an example, the power supply circuit 200 constitutes a step-down switching regulator, and includes a transistor 201, a diode 202, a PWM modulation circuit 203, a capacitor 204, an inductor 205, and resistance elements 206, 207, and 208. The PWM modulation circuit 203 generates a pulse signal corresponding to a PWM signal A1 from a digital signal supplied from the analog digital converter 24, and supplies the generated pulse signal to a gate of the transistor 201. The transistor 201 is turned ON/OFF according to the pulse signal so that an output signal Vₒᵤₜ in which the level of an input voltage Vᵢₙ input to an input terminal 210 is lowered is output from an output terminal 211. The level of the output voltage Vₒᵤₜ is the level corresponding to the duty of the pulse signal. When the output voltage Vₒᵤₜ is output from the output terminal 211, an output current Iₒᵤₜ flows through a load 220 connected to the output terminal 211.

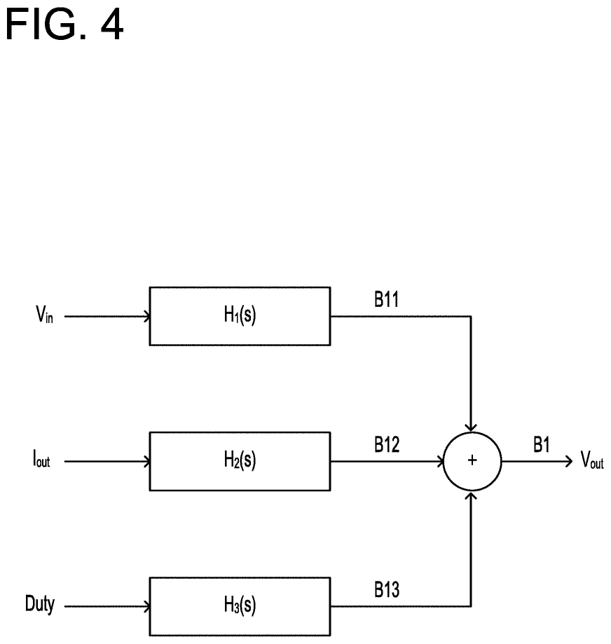

The characteristics of the power supply circuit 200 illustrated in FIG. 3 may be expressed using transfer functions H₁(s), H₂(s), and H₃(s) illustrated in FIG. 4. The transfer function H₁(s) is a transfer function expressing the relationship between the input voltage Vᵢₙ and the output voltage Vₒᵤₜ, and is represented by the following equation (1).

$$[ Equation 1 ]$$

$${H}_{1} ( s ) = \frac{Δ {V}_{out} ( s )}{Δ {V}_{in} ( s )} \qquad ( 1 )$$

The transfer function H₂(s) is a transfer function expressing the relationship between the output current Iₒᵤₜ and the output voltage Vₒᵤₜ, and is represented by the following equation (2).

$$[ Equation 2 ]$$

$${H}_{2} ( s ) = \frac{Δ {V}_{out} ( s )}{Δ {I}_{out} ( s )} \qquad ( 2 )$$

The transfer function H₃(s) is a transfer function expressing the relationship between the duty of the PWM signal A1 and the output voltage Vₒᵤₜ, and is represented by the following equation (3).

$$[ Equation 3 ]$$

$${H}_{3} ( s ) = \frac{Δ {V}_{out} ( s )}{Δ Duty ( s )} \qquad ( 3 )$$

All of the transfer functions H₁(s), H₂(s), and H₃(s) may be expressed in the form represented by the following equation (4).

$$[ Equation 4 ]$$

$$H ( s ) = \frac{{b}_{1} {s}^{k} + {b}_{1} {s}^{k - 1} + ⋯ + {b}_{k}}{{s}^{k} + {a}_{1} {s}^{k - 1} + ⋯ + {a}_{k}} \qquad ( 4 )$$

A response output B11 is obtained by inputting the input voltage Vᵢₙ to the transfer function H₁(s). A response output B12 is obtained by inputting the output current Iₒᵤₜ to the transfer function H₂(s). A response output B13 is obtained by inputting the duty of the PWM signal A1 to the transfer function H₃(s). By adding up the response output B11, the response output B12, and the response output B13, it is possible to derive a response output B1 indicating the output voltage Vₒᵤₜ corresponding to a combination of the input voltage Vᵢₙ, the output current Iₒᵤₜ, and the duty of the PWM signal A1.

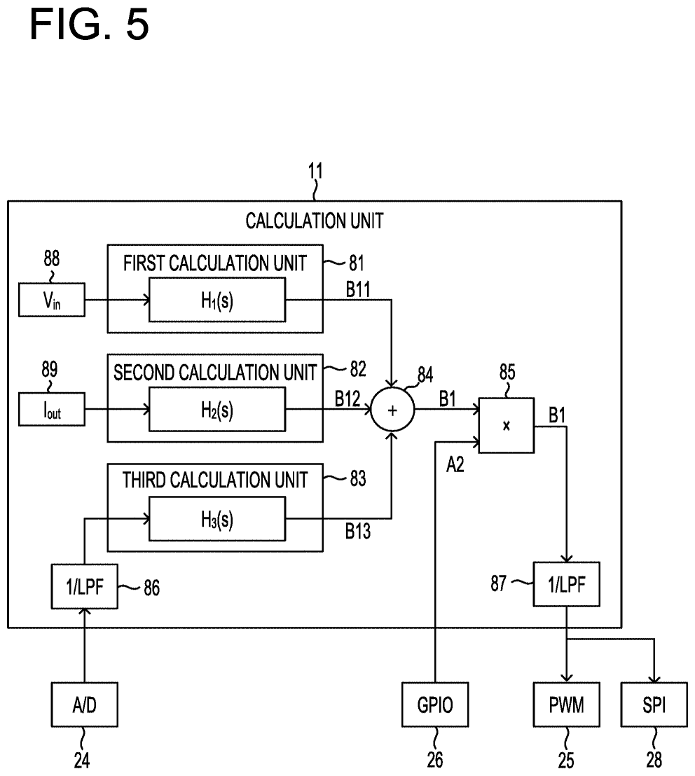

FIG. 5 is a functional block diagram illustrating an example of a more specific functional configuration of the calculation unit 11 illustrated in FIG. 1. The calculation unit 11 includes a first calculation unit 81, a second calculation unit 82, a third calculation unit 83, an adding unit 84, a multiplication unit 85, compensation units 86 and 87, and registers 88 and 89.

The first calculation unit 81 derives a response output B11 to a set value of the input voltage Vᵢₙ stored in the register 88, by a calculation using the transfer function H₁(s). The second calculation unit 82 derives a response output B12 to a set value of the output current Iₒᵤₜ stored in the register 89, by a calculation using the transfer function H₂(s). The third calculation unit 83 derives a response output B13 to a digital signal that is supplied from the analog digital converter 24 and indicates the duty of the PWM signal A1, by a calculation using the transfer function H₃(s).

The adding unit 84 outputs a result obtained by adding the response output B11 derived by the first calculation unit 81, the response output B12 derived by the second calculation unit 82, and the response output B13 derived by the third calculation unit 83, as a final response output B1. The final response output B1 indicates the output voltage Vₒᵤₜ corresponding to a combination of the set value of the input voltage Vᵢₙ, the set value of the output current Iₒᵤₜ, and the duty of the PWM A1 which are input to the first calculation unit 81, the second calculation unit 82, and the third calculation unit 83, respectively.

The multiplication unit 85 performs a processing of multiplying the ON/OFF switching signal A2 by the final response output B1. The multiplication unit 85 sends the final response output B1 when the signal value of the ON/OFF switching signal A2 supplied from the control MCU 4 is “1,” and does not send the final response output B1 when the signal value of the ON/OFF switching signal A2 is “0.” That is, the multiplication unit 85 determines whether to send the final response output B1 on the basis of the ON/OFF switching signal A2.

The compensation unit 86 performs a compensation processing on the digital signal that is supplied from the analog digital converter 24 and corresponds to the PWM signal A1, by using a filter corresponding to the inverse characteristic of the low pass filter 34. This compensates the deterioration of a control characteristic which occurs when the PWM signal A1 supplied from the control MCU 4 passes through the low pass filter 34.

Likewise, the compensation unit 87 performs a compensation processing on the final response output B1 to be sent from the multiplication unit 85, by using a filter corresponding to the inverse characteristic of the low pass filter 35. This compensates the deterioration of a control characteristic which occurs when the PWM signal B2 that is output from the PWM signal generating circuit 25 and corresponds to the response output B1 passes through the low pass filter 35.

Hereinafter, descriptions will be made on the operation of the simulation apparatus 1 according to the embodiment of the present disclosure.

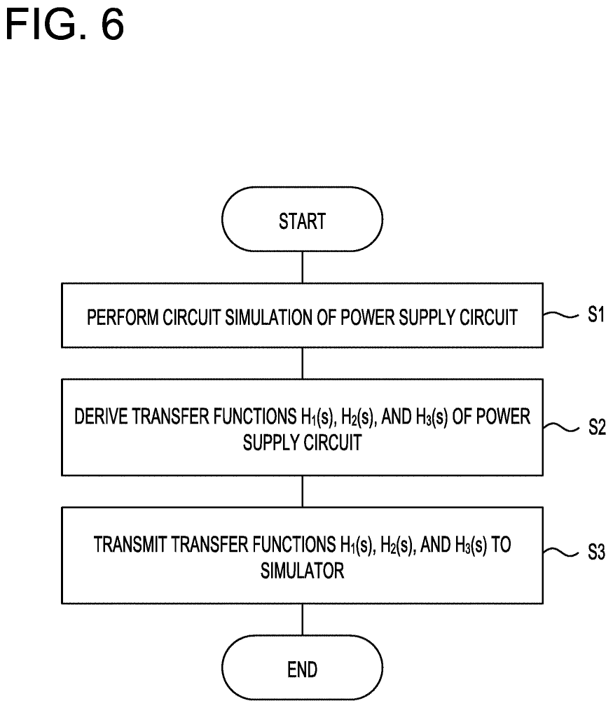

First, descriptions will be made on a transfer function derivation process performed when the CPU 51 of the interface PC 3 executes the transfer function derivation program 102. FIG. 6 is a flowchart illustrating an example of the flow of the transfer function derivation process described above.

In operation S1, the CPU 51 of the interface PC 3 performs circuit simulation using the power supply circuit model 103 stored in the auxiliary storage device 53, as illustrated in FIG. 3, and analyzes input/output characteristics of the corresponding power supply circuit.

In operation S2, the CPU 51 derives transfer functions H₁(s), H₂(s), and H₃(s) indicating the characteristics of the power supply circuit on the basis of the analysis result of the input/output characteristics of the corresponding power supply circuit. The transfer function H₁(s) expresses the relationship between an input voltage Vᵢₙ and an output voltage Vₒᵤₜ. The transfer function H₂(s) expresses the relationship between an output current Iₒᵤₜ and the output voltage Vₒᵤₜ. The transfer function H₃(s) expresses the relationship between the duty of the PWM signal A1 and the output voltage Vₒᵤₜ.

In operation S3, the CPU 51 transmits the derived transfer functions H₁(s), H₂(s), and H₃(s) to the simulator 2 via the USB interface 56 and the programmer 70. The transfer functions H₁(s), H₂(s), and H₃(s) transmitted to the simulator 2 are stored in, for example, a register (not illustrated) of the CPU 21 of the calculation MCU 20.

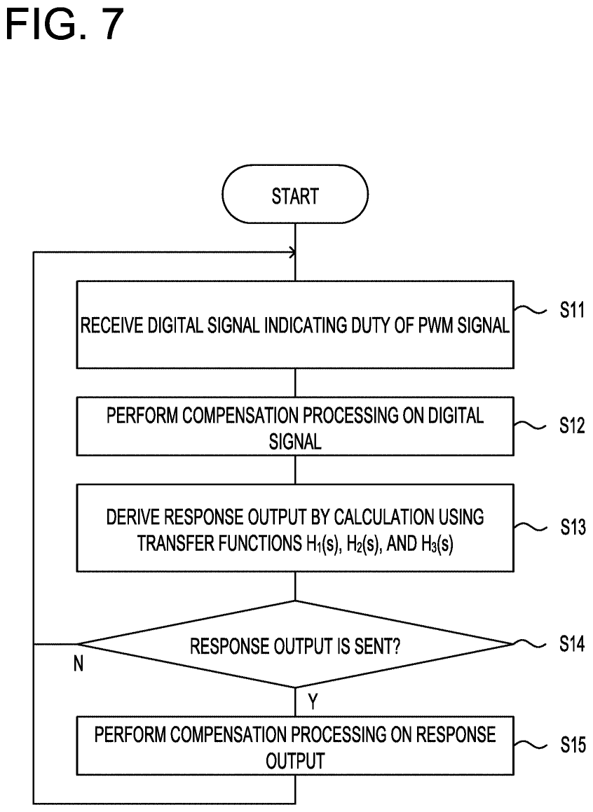

Next, descriptions will be made on an arithmetic processing performed when the CPU 21 of the calculation MCU 20 executes the calculation program 100. FIG. 7 is a flowchart illustrating an example of the flow of the above-described arithmetic processing. In addition, it is assumed that the transfer functions H₁(s), H₂(s), and H₃(s) transmitted from the interface PC 3 are stored in the register of the CPU 21 of the calculation MCU 20.

The PWM signal A1 output from the control MCU 4 is supplied to the CPU 21 of the calculation MCU 20 via the level shifter 31, the low pass filter 34, and the analog digital converter 24. The level shifter 31 shifts the level of the PWM signal A1 supplied from the control MCU 4, to a level suitable for the calculation MCU 20. The low pass filter 34 averages the level of the level-shifted PWM signal A1. That is, the low pass filter 34 converts the duty of the PWM signal A1 into a voltage level. The analog digital converter 24 converts the signal supplied from the low pass filter 34 into a digital signal, and supplies the digital signal to the CPU 21.

In operation S11, the CPU 21 receives the digital signal that is supplied from the analog digital converter 24 and indicates the duty of the PWM signal A1.

In operation S12, the CPU 21 functions as the compensation unit 86 (see FIG. 5), and performs a compensation processing on the digital signal received in operation S11, by using a filter corresponding to the inverse characteristic of the low pass filter 34. This compensates the deterioration of a control characteristic which occurs when the PWM signal A1 supplied from the control MCU 4 passes through the low pass filter 34.

In operation S13, the CPU 21 derives the response output B1 by a calculation using the transfer functions H₁(s), H₂(s), and H₃(s). That is, the CPU 21 that functions as the first calculation unit 81 derives the response output B11 to a set value of the input voltage Vᵢₙ stored in the register 88, by a calculation using the transfer function H₁(s). The CPU 21 that functions as the second calculation unit 82 derives the response output B12 to a set value of the output current Iₒᵤₜ stored in the register 89, by a calculation using the transfer function H₂(s). The CPU 21 that functions as the third calculation unit 83 derives the response output B13 to the digital signal that is supplied from the analog digital converter 24 and indicates the duty of the PWM signal A1, by a calculation using the transfer function H₃(s). The CPU 21 that functions as the adding unit 84 adds up the response outputs B11, B12, and B13, and outputs the result as a final response output B1. The final response output B1 indicates the output voltage Vₒᵤₜ corresponding to a combination of the set value of the input voltage Vᵢₙ, the set value of the output current Iₒᵤₜ, and the duty of the PWM signal A1 which are input to the first calculation unit 81, the second calculation unit 82, and the third calculation unit 83, respectively.

In operation S14, the CPU 21 functions as the multiplication unit 85, and determines whether to send the final response output B1 derived in operation S13 on the basis of the ON/OFF switching signal A2 supplied from the control MCU 4. When the signal value of the ON/OFF switching signal A2 is “1,” the CPU 21 determines to send the response output B1, and the process proceeds to operation S15. Meanwhile, when the signal value of the ON/OFF switching signal A2 is “0,” the CPU 21 determines not to send the response output B1. In this case, the process returns to operation S11.

In operation S15, the CPU 21 functions as the compensation unit 87, and performs a compensation processing on the final response output B1 derived in operation S13, by using a filter corresponding to the inverse characteristic of the low pass filter 35. This compensates the deterioration of a control characteristic which occurs when the PWM signal B2 that is output from the PWM signal generating circuit 25 and corresponds to the response output B1 passes through the low pass filter 35. The response output B1 subjected to the compensation processing is supplied to the data transmission MCU 40 via the SPI 28, and simultaneously, supplied to the PWM signal generating circuit 25. When the processing in operation S15 is completed, the process returns to operation S11.

The PWM signal generating circuit 25 that has received the response output B1 generates the PWM signal B2 having a duty corresponding to the output voltage as the response output B1, and supplies the generated PWM signal B2 to the low pass filter 35. The low pass filter 35 averages the level of the PWM signal B2. That is, the low pass filter 35 converts the duty of the PWM signal B2 into a voltage level. The level shifter 32 shifts the level of the signal supplied from the low pass filter 35, to a level suitable for the control MCU 4, and supplies the signal with the shifted level as the response signal B3 to the control MCU 4.

The analog digital converter 63 of the control MCU 4 converts the response signal B3 supplied from the simulator 2, into a digital signal, and supplies the digital signal to the CPU 61. The CPU 61 updates the duty command value to be supplied to the PWM signal generating circuit 62 on the basis of the digital signal supplied from the analog digital converter 63. The simulator 2 repeatedly performs a processing of feeding the response output B1 to the PWM signal A1 corresponding to the updated duty command value, back to the control MCU 4.

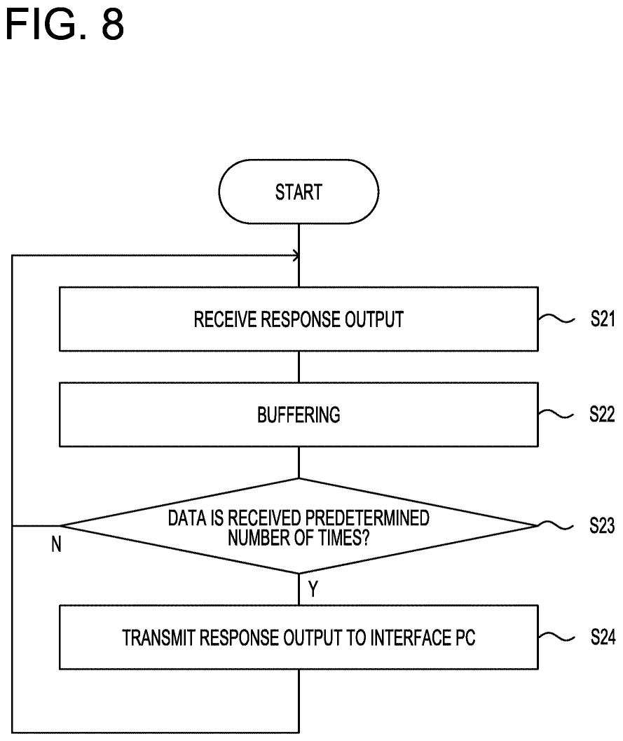

Next, descriptions will be made on a data transmission process performed when the CPU 41 of the data transmission MCU 40 executes the data transmission program 101. FIG. 8 is a flowchart illustrating an example of the flow of the above-described data transmission process.

In operation S21, the CPU 41 receives the response output B1 supplied from the calculation MCU 20.

In operation S22, the CPU 41 performs a buffering processing of accumulating the received response output B1 in the main storage device 42 or the auxiliary storage device 43.

In operation S23, the CPU 41 determines whether the number of receptions of the response output B1 reaches a predetermined number (e.g., 10 times). That is, the CPU 41 determines whether the number of response outputs B1 accumulated by the buffering processing reaches a predetermined number. When the CPU 41 determines that the number of receptions of the response output B1 reaches the predetermined number, the process proceeds to operation S24, and when the CPU 41 determines that the number of receptions of the response output B1 does not reach the predetermined number, the process returns to operation S21.

In operation S24, the CPU 41 transmits the plurality of response outputs B1 accumulated in the main storage device 42 or the auxiliary storage device 43, to the interface PC 3.

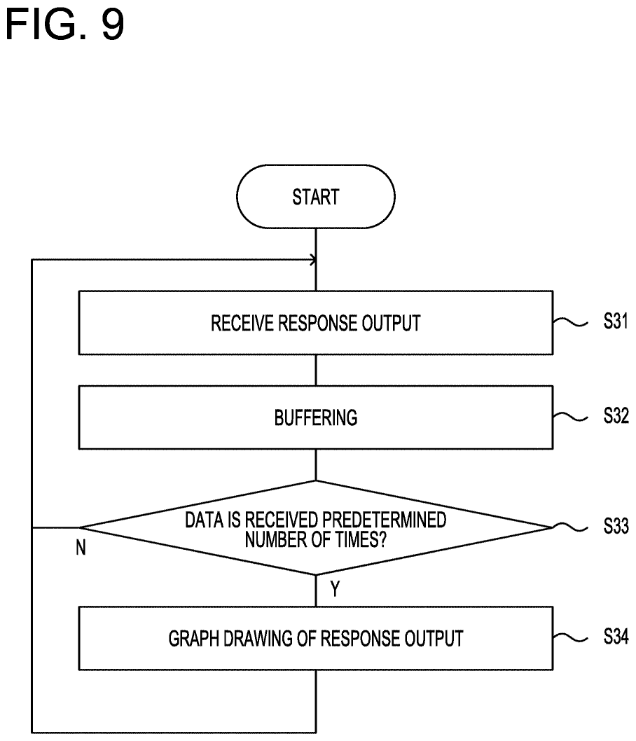

Next, descriptions will be made on a display control process performed when the CPU 51 of the interface PC 3 executes the display processing program 104. FIG. 9 is a flowchart illustrating an example of the flow of the above-described display control process.

In operation S31, the CPU 51 receives the plurality of response outputs B1 transmitted from the data transmission MCU 40.

In operation S32, the CPU 51 performs a buffering processing of accumulating the plurality of received response outputs B1 in the main storage device 52 or the auxiliary storage device 53.

In operation S33, the CPU 51 determines whether the number of receptions of the response outputs B1 reaches a predetermined number (e.g., 10 times). That is, the CPU 51 determines whether the number of response outputs B1 accumulated by the buffering processing reaches a predetermined number (e.g., 100). When the CPU 51 determines that the number of receptions of the response outputs B1 reaches the predetermined number, the process proceeds to operation S34, and when the CPU 51 determines that the number of receptions of the response outputs B1 does not reach the predetermined number, the process returns to operation S31.

In operation S34, the CPU 51 draws a graph of the output voltage Vₒᵤₜ on the basis of the plurality of response outputs B1 accumulated in the main storage device 52 or the auxiliary storage device 53. That is, the CPU 51 displays an output voltage waveform of the power supply circuit on the display screen of the display device 55.

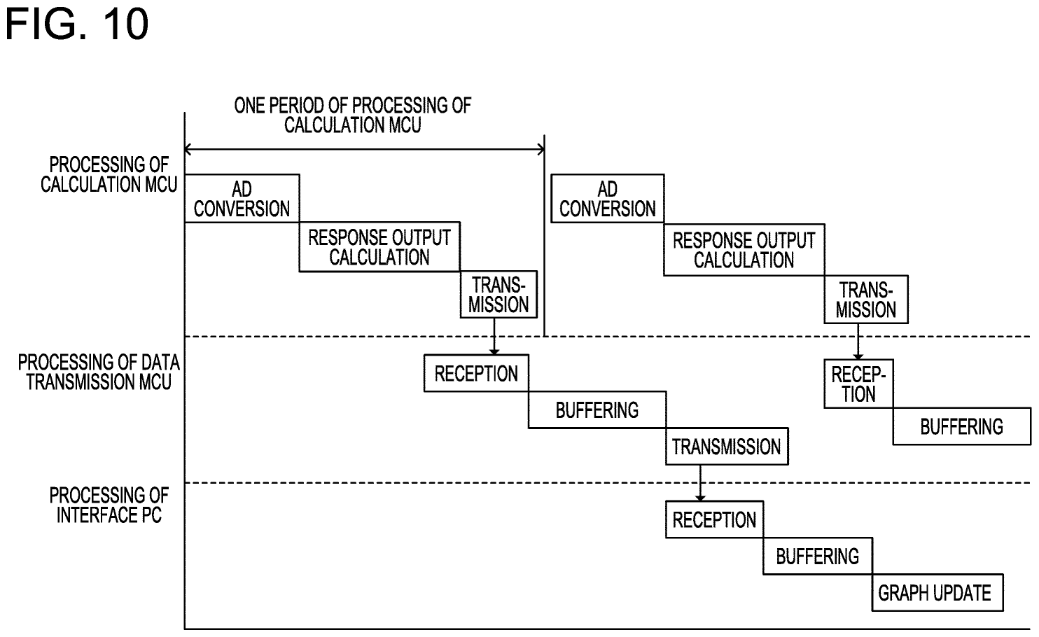

FIG. 10 is a timing chart illustrating a cooperation of processes in the calculation MCU 20, the data transmission MCU 40, and the interface PC 3. The response output B1 that is derived by the calculation MCU 20 and indicates the output voltage of the power supply circuit is received by the data transmission MCU 40.

The data transmission MCU 40 buffers the response output B1 derived by the calculation MCU 20. Each time the response output B1 is received, for example, 10 times from the calculation MCU 20, the data transmission MCU 40 transmits the plurality of accumulated response outputs B1, as collective data, to the interface PC 3.

The interface PC 3 buffers the plurality of response outputs B1 collectively transmitted from the data transmission MCU 40. Each time the data of the response outputs B1 is received, for example, 10 times from the data transmission MCU 40, the interface PC 3 updates the output voltage waveform displayed on the display device 55.

In this manner, through the cooperation of the calculation MCU 20, the data transmission MCU 40, and the interface PC 3, it is possible to perform the derivation of the response output B1 and the graph drawing of the output voltage Vₒᵤₜ based on the derived response output B1, in parallel.

As described above, in the simulation apparatus 1 according to the embodiment of the disclosed technology, the response output B1 indicating the output voltage of the power supply circuit is derived by a calculation using the transfer functions H₁(s), H₂(s), and H₃(s) expressing the power supply circuit. Thus, it is possible to dramatically reduce the time required for an arithmetic processing, as compared with the method of the related art in which it is required to repeatedly solve a circuit equation for each node of the power supply circuit. This makes it possible to perform a real-time simulation of the power supply device in the HILS process.

Further, in the simulation apparatus 1 according to the embodiment of the present disclosure, the PWM signal A1 output from the control MCU 4 is averaged by the low pass filter 34 constituting the input processor 10. That is, the low pass filter 34 converts the duty of the PWM signal A1 into a voltage level. Since the conversion frequency of the analog digital converter 24 provided in the calculation MCU 20 is smaller than the frequency of the PWM signal A1, it is difficult for the analog digital converter 24 to directly process the PWM signal A1. By converting the duty of the PWM signal A1 into the voltage level by the low pass filter 34 constituting the input processor 10, the PWM signal A1 may be processed by the analog digital converter 24.

Further, in the simulation apparatus 1 according to the embodiment of the present disclosure, the PWM signal B2 output from the calculation MCU 20 is averaged by the low pass filter 35 constituting the output processor 13. That is, the low pass filter 35 converts the duty of the PWM signal B2 into a voltage level. Since the conversion frequency of the analog digital converter 63 provided in the control MCU 4 is smaller than the frequency of the PWM signal B2, it is difficult for the analog digital converter 63 to directly process the PWM signal B2. By converting the duty of the PWM signal B2 into the voltage level by the low pass filter 35 constituting the output processor 13, the PWM signal B2 may be processed by the analog digital converter 63.

Further, in the simulation apparatus 1 according to the embodiment of the present disclosure, the response output B1 derived by the calculation MCU 20 is transmitted to the interface PC 3 by the data transmission MCU 40. Since the data transmission MCU 40 performs the process of transmitting the response output B1, the calculation MCU 20 may allocate most of hardware resources to the arithmetic processing. This may facilitate speeding-up of the arithmetic processing.

Further, in the embodiment described above, a case where the output voltage waveform (i.e., the time transition of the response output B1) is displayed on the display screen of the display device 55 of the interface PC 3 has been described as an example. However, the present disclosure is not limited to this aspect. That is, the simulation apparatus 1 may be configured such that the input voltage waveform, the output voltage waveform, the PWM signal waveform, the time transition of the response outputs B11, B12, and B13, etc., are displayed on the display screen of the display device 55.

### Second Embodiment

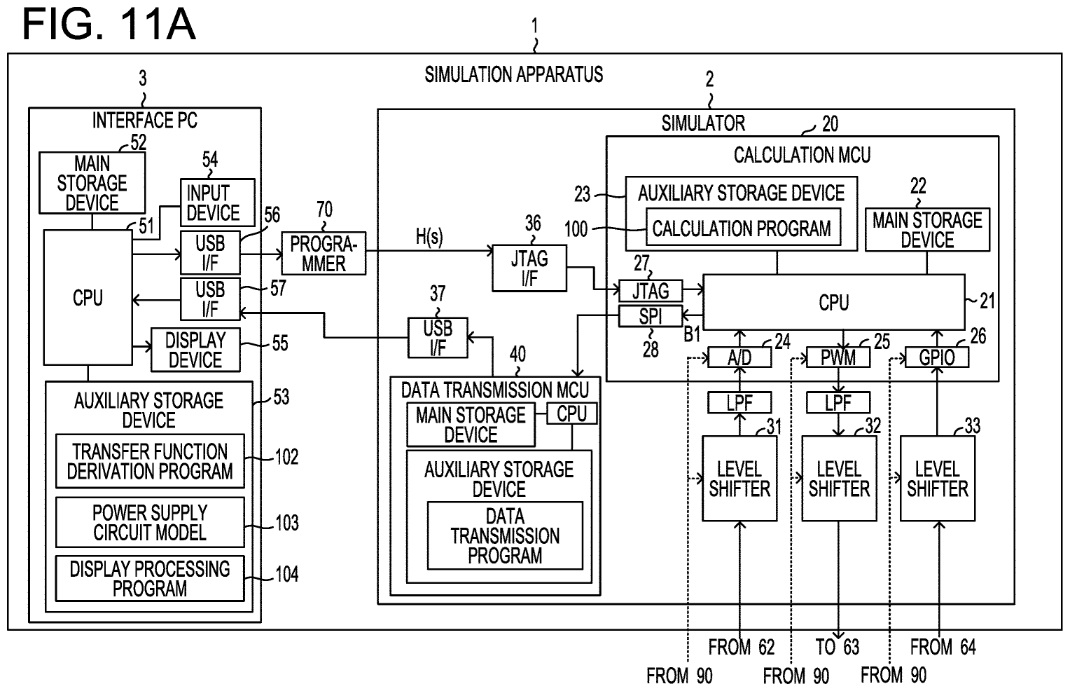

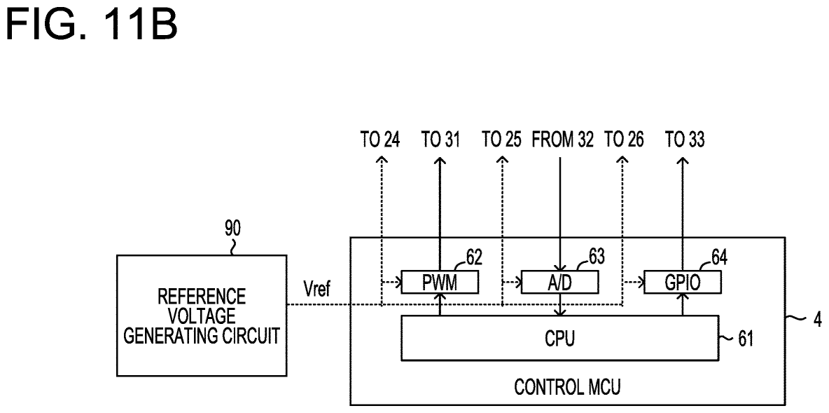

FIGS. 11A and 11B are views illustrating an example of a hardware configuration of a simulation apparatus 1 according to a second embodiment of the present disclosure.

The simulation apparatus 1 according to the second embodiment includes a reference voltage generating circuit 90 that generates a reference voltage Vref. The reference voltage Vref output from the reference voltage generating circuit 90 is commonly used for the blocks that constitute the control MCU 4 and the input processor 10 and the output processor 13 of the simulator 2. Specifically, the reference voltage Vref is supplied to the PWM signal generating circuit 62, the analog digital converter 63, and the GPIO 64 that constitute the control MCU 4. Further, the reference voltage Vref is supplied to the level shifters 31, 32, and 33, the analog digital converter 24, the PWM signal generating circuit 25, and the GPIO 26 that constitute the simulator 2.

Each of the analog digital converters 24 and 63 converts an input analog signal into a digital value with reference to the reference voltage Vref. The digital values output from the analog digital converters 24 and 63 vary according to the reference voltage Vref.

Each of the PWM signal generating circuits 25 and 62 generates a PWM signal having a duty corresponding to the level of an input voltage with reference to the reference voltage Vref. The PWM signals output from the PWM signal generating circuits 25 and 62 vary according to the reference voltage Vref.

Each of the level shifters 31, 32, and 33 shifts the level of an input voltage with reference to the reference voltage Vref. The signals output from the level shifters 31, 32, and 33 vary according to the reference voltage Vref.

Therefore, when a deviation occurs between the reference voltage used in the control MCU 4 and the reference voltage used in the simulator 2, there is a concern that a deviation may occur between signals transmitted/received between the control MCU 4 and the simulator 2, and as a result, the control characteristic may be deteriorated.

In the simulation apparatus 1 according to the present embodiment, the common reference voltage Vref is supplied to the blocks that constitute the control MCU 4 and the input processor 10 and the output processor 13 of the simulator 2. Therefore, it is possible to prevent a deviation from occurring between the reference voltage used in the control MCU 4 and the reference voltage used in the simulator 2.

### Third Embodiment

In a simulation apparatus according to a third embodiment of the present disclosure, among the functions of the calculation unit 11 illustrated in FIG. 5, the functions of the compensation units 86 and 87 are included in the transfer function derived in the interface PC 3.

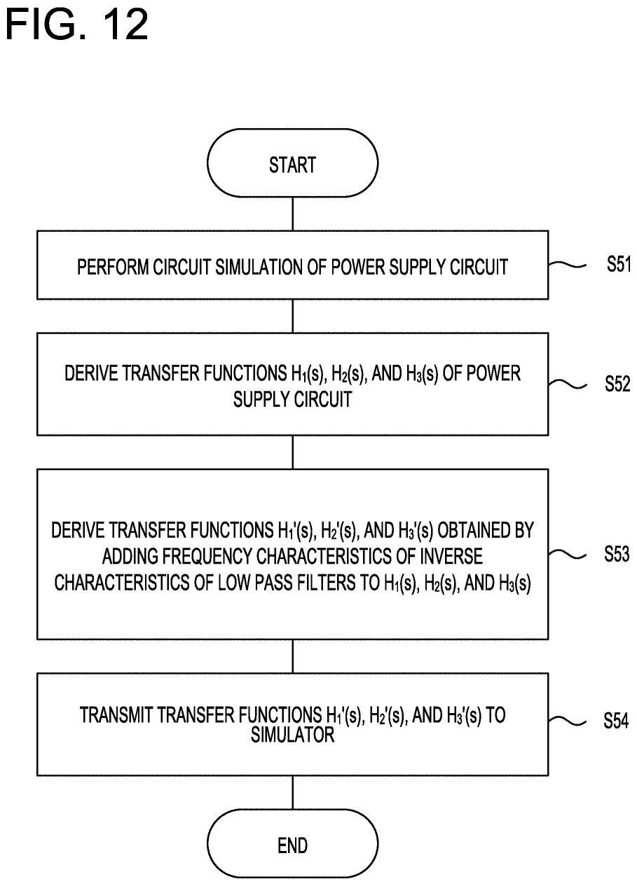

FIG. 12 is a flowchart illustrating an example of a transfer function derivation process performed when the CPU 51 of the interface PC 3 according to the third embodiment of the present disclosure executes the transfer function derivation program 102.

In operation S51, the CPU 51 of the interface PC 3 performs circuit simulation using the power supply circuit model 103 stored in the auxiliary storage device 53, as illustrated in FIG. 3, and analyzes input/output characteristics of the corresponding power supply circuit.

In operation S52, the CPU 51 derives transfer functions H₁(s), H₂(s), and H₃(s) indicating the characteristics of the power supply circuit on the basis of the analysis result of the input/output characteristics of the corresponding power supply circuit. The transfer function H₁(s) expresses the relationship between an input voltage Vᵢₙ and an output voltage Vₒᵤₜ. The transfer function H₂(s) expresses the relationship between an output current Iₒᵤₜ and the output voltage Vₒᵤₜ. The transfer function H₃(s) expresses the relationship between the duty of the PWM signal A1 and the output voltage Vₒᵤₜ.

In operation S53, the CPU 51 derives transfer functions H₁′(s), H₂′(s), and H₃′(s) obtained by adding frequency characteristics of the inverse characteristics of the low pass filters 34 and 35 to the transfer functions H₁(s), H₂(s), and H₃(s) derived in operation S52. That is, the CPU 51 causes each of the transfer functions H₁′(s) and H₂′(s) to include the frequency characteristic of the inverse characteristic of the low pass filter 35. The CPU 51 causes the transfer function H₃′(s) to include the frequency characteristic of the inverse characteristic of the low pass filter 34 and the frequency characteristic of the inverse characteristic of the low pass filter 35.

Here, the frequency characteristic (a transfer function) of the low pass filter 34 is set as H_{LPF1}(s), and the frequency characteristic (a transfer function) of the low pass filter 35 is set as H_{LPF2}(s). In this case, the frequency characteristic (a transfer function) of the inverse characteristic of the low pass filter 34 becomes 1/H_{LPF1}(s), and the frequency characteristic (a transfer function) of the inverse characteristic of the low pass filter 35 becomes 1/H_{LPF2}(s). Therefore, the transfer functions H₁′(s), H₂′(s), and H₃′(s) may be represented by the following equations (5), (6), and (7), respectively.

$$\begin{matrix}[ Equation 5 ] & \\ {H}_{1}^{′} ( s ) = {H}_{1} ( s ) \frac{1}{{H}_{LPF 2} ( s )} & ( 5 ) \\ [ Equation 6 ] & \\ {H}_{2}^{′} ( s ) = {H}_{2} ( s ) \frac{1}{{H}_{LPF 2} ( s )} & ( 6 ) \\ [ Equation 7 ] & \\ {H}_{3}^{′} ( s ) = {H}_{3} ( s ) \frac{1}{{H}_{LPF 1} ( s ) \cdot {H}_{LPF 2} ( s )} & ( 7 )\end{matrix}$$

In addition, when each of the low pass filters 34 and 35 is a first-order low pass filter, H_{LPF1}(s) and H_{LPF2}(s) may be represented by the following equations (8) and (9), respectively. Therefore, each of the transfer functions H₁′(s) and H₂′(s) may be represented by the form of the equation (10), and the transfer function H₃′(s) may be represented by the form of the equation (11).

$$\begin{matrix}[ Equation 8 ] & \\ {H}_{LPF 1} ( s ) = \frac{1}{{q}_{1} ( s ) + 1} & ( 8 ) \\ [ Equation 9 ] & \\ {H}_{LPF 2} ( s ) = \frac{1}{{q}_{ 2} ( s ) + 1} & ( 9 ) \\ [ Equation 10 ] & \\ {H}^{′} ( s ) = \frac{{b}_{1} {s}^{k} + {b}_{1} {s}^{k - 1} + ⋯ + {b}_{k}}{{s}^{k} + {a}_{1} {s}^{k - 1} + ⋯ + {a}_{k}} \cdot \frac{{q}_{2} ( s ) + 1}{1} & ( 10 ) \\ [ Equation 11 ] & \\ {H}^{′} ( s ) = \frac{{b}_{2} {s}^{k} + {b}_{2} {s}^{k - 1} + ⋯ + {b}_{k}}{{s}^{k} + {a}_{2} {s}^{k - 1} + ⋯ + {a}_{k}} \cdot \frac{{g}_{2} ( s ) + 1}{1} \cdot \frac{{q}_{2} ( s ) + 1}{1} & ( 11 )\end{matrix}$$

In operation S54, the CPU 51 transmits the derived transfer functions H′₁(s), H′₂(s), and H′₃(s) to the simulator 2 via the USB interface 56 and the programmer 70. The transfer functions H′₁(s), H′₂(s), and H′₃(s) transmitted to the simulator 2 are stored in, for example, a register (not illustrated) of the CPU 21 of the calculation MCU 20.

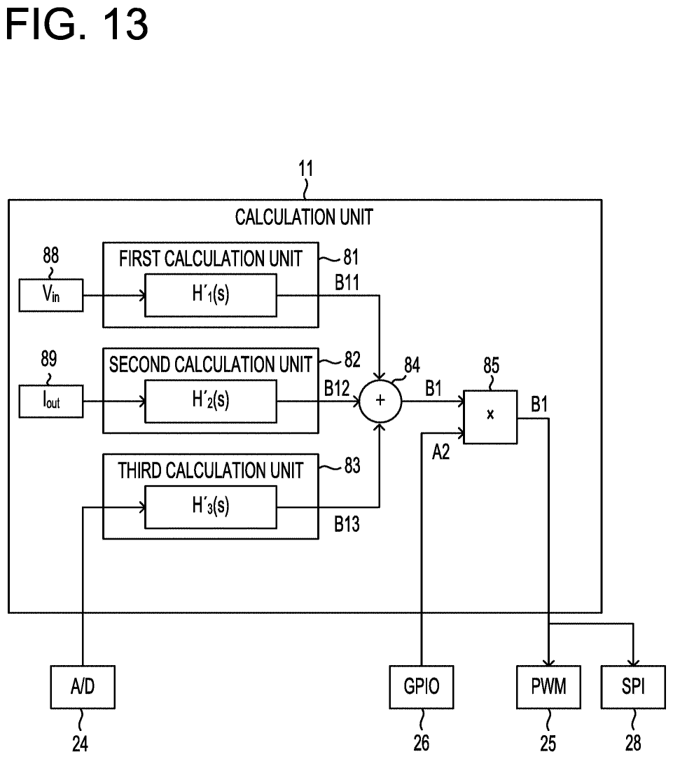

FIG. 13 is a functional block diagram illustrating an example of a functional configuration of the calculation unit 11 according to the third embodiment. The calculation unit 11 according to the present embodiment includes the first calculation unit 81, the second calculation unit 82, the third calculation unit 83, the adding unit 84, the multiplication unit 85, and the registers 88 and 89. That is, in the third embodiment, as described above, since the functions of the compensation units 86 and 87 may be included in the transfer functions H′₁(s), H′₂(s), and H′₃(s), the calculation unit 11 according to the third embodiment does not include the compensation units 86 and 87 which are included in the calculation unit 11 (see FIG. 5) according to the first embodiment.

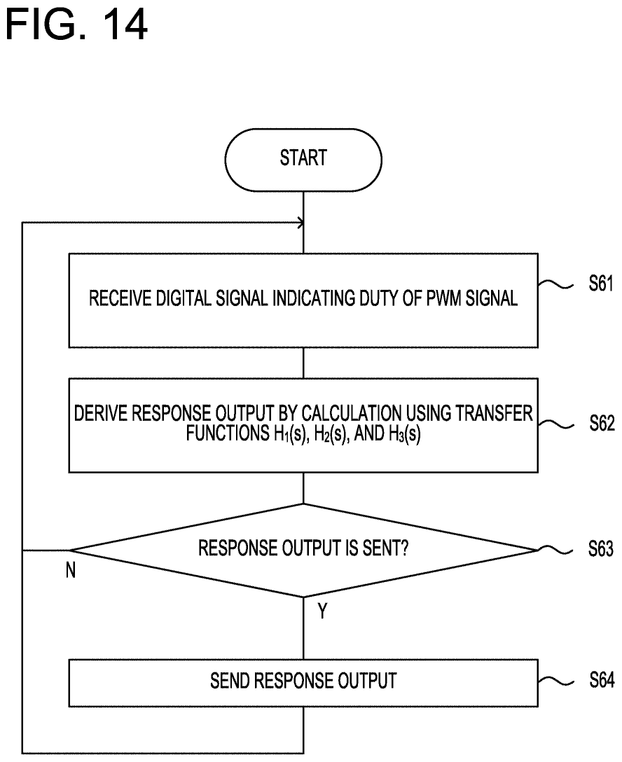

FIG. 14 is a flowchart illustrating an example of the flow of an arithmetic processing according to the third embodiment, which is performed when the CPU 21 of the calculation MCU 20 executes the calculation program 100. In addition, it is assumed that the transfer functions H′₁(s), H′₂(s), and H′₃(s) transmitted from the interface PC 3 are stored in the register of the CPU 21 of the calculation MCU 20. Each of the transfer functions H′₁(s) and H′₂(s) includes the frequency characteristic of the inverse characteristic of the low pass filter 35, and the transfer function H′₃(s) includes the frequency characteristic of the inverse characteristic of the low pass filter 34 and the frequency characteristic of the inverse characteristic of the low pass filter 35.

In operation S61, the CPU 21 receives the digital signal that is supplied from the analog digital converter 24 and indicates the duty of the PWM signal A1.

In operation S62, the CPU 21 derives the response output B1 by a calculation using the transfer functions H′₁(s), H′₂(s), and H′₃(s). That is, the CPU 21 that functions as the first calculation unit 81 derives a response output B11 to a set value of the input voltage Vᵢₙ stored in the register 88, by a calculation using the transfer function H′₁(s). The CPU 21 that functions as the second calculation unit 82 derives a response output B12 to a set value of the output current Iₒᵤₜ stored in the register 89, by a calculation using the transfer function H′₂(s). The CPU 21 that functions as the third calculation unit 83 derives a response output B13 to the digital signal that is supplied from the analog digital converter 24 and indicates the duty of the PWM signal A1, by a calculation using the transfer function H′₃(s). The CPU 21 that functions as the adding unit 84 adds up the response outputs B11, B12, and B13, and outputs the result as a final response output B1. The final response output B1 indicates the output voltage Vₒᵤₜ corresponding to a combination of the set value of the input voltage Vᵢₙ, the set value of the output current Iₒᵤₜ, and the duty of the PWM signal A1 which are input to the first calculation unit 81, the second calculation unit 82, and the third calculation unit 83, respectively.

In operation S63, the CPU 21 functions as the multiplication unit 85, and determines whether to send the final response output B1 derived in operation S62 on the basis of the ON/OFF switching signal A2 supplied from the control MCU 4. The CPU 21 sends the response output B1 in operation S64 when the signal value of the ON/OFF switching signal A2 is “1,” and does not send the response output B1 when the signal value of the ON/OFF switching signal A2 is “0.” Then, the process returns to operation S61.

In operation S63, the CPU 21 functions as the multiplication unit 85, and determines whether to send the final response output B1 derived in operation S62 on the basis of the ON/OFF switching signal A2 supplied from the control MCU 4. When the signal value of the ON/OFF switching signal A2 is “1,” the CPU 21 determines to send the response output B1. In this case, the response output B1 is supplied to the data transmission MCU 40 via the SPI 28, and simultaneously, supplied to the PWM signal generating circuit 25. Then, the process returns to operation S61. Meanwhile, when the signal value of the ON/OFF switching signal A2 is “0,” the CPU 21 determines not to send the response output B1. In this case, the response output B1 is not sent from the CPU 21, and the process returns to operation S61.

In the simulation apparatus according to the third embodiment of the present disclosure, each of the transfer functions H′₁(s) and H′₂(s) includes the frequency characteristic of the inverse characteristic of the low pass filter 35. In addition, the transfer function H′₃(s) includes the frequency characteristic of the inverse characteristic of the low pass filter 34 and the frequency characteristic of the inverse characteristic of the low pass filter 35. Therefore, among the functions implemented by the CPU 21 of the calculation MCU 20, the functions of the compensation units 86 and 87 may be reduced. In other words, it is possible to omit the processings in operations S12 and S15 in the arithmetic processing according to the first embodiment (see FIG. 7). Thus, it is possible to reduce the time required for the arithmetic processing in the CPU 21 of the calculation MCU 20.

Further, since the transfer functions H′₁(s), H′₂(s), and H′₃(s) include the frequency characteristics of the inverse characteristics of the low pass filters, one order of the transfer function may be reduced. This makes it possible to reduce the number of calculations in the calculation MCU 20.

[Trial Product and Verification]

The simulation apparatus according to the embodiment of the present disclosure was experimentally produced, and comparison to characteristics of the actual power supply circuit was performed. Specifications of the experimentally produced simulation apparatus are as follows.

MCU for calculation: TMS320F28335, 150 MHz, floating point unit, 256 Kbyte memory

Conversion frequency of analog digital converter: 200 kHz

Calculation frequency using transfer function: 200 kHz

MCU for data transmission: Arduino DUE

The power supply circuit simulated by the simulation apparatus and the actual power supply circuit were operated under the following conditions.

Input voltage: 9 V

Output voltage: 1.05 V

Output current: 1 A

Switching frequency: 100 kHz

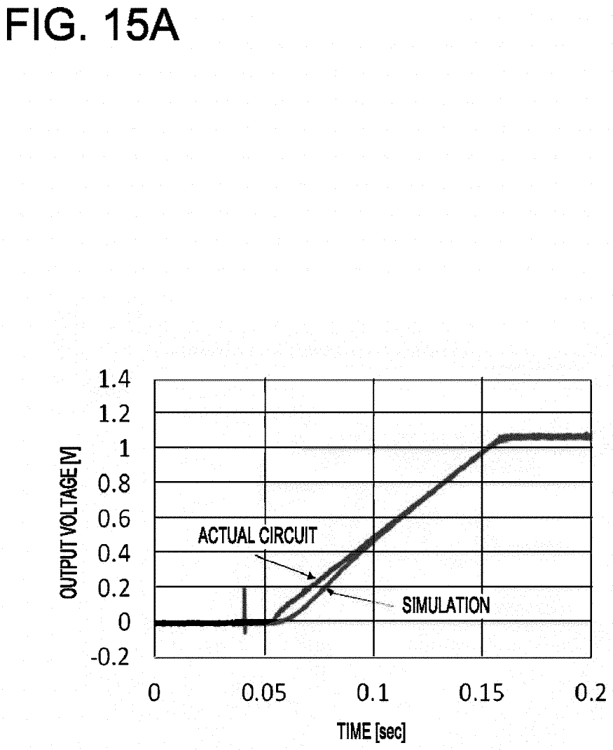

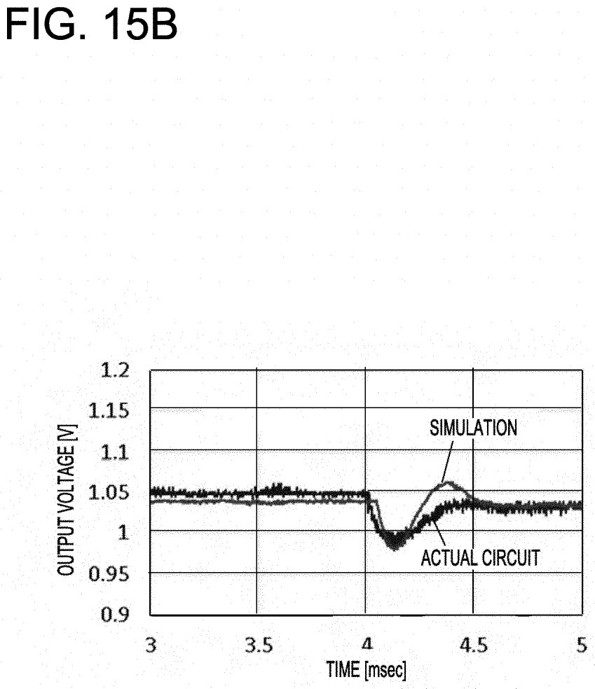

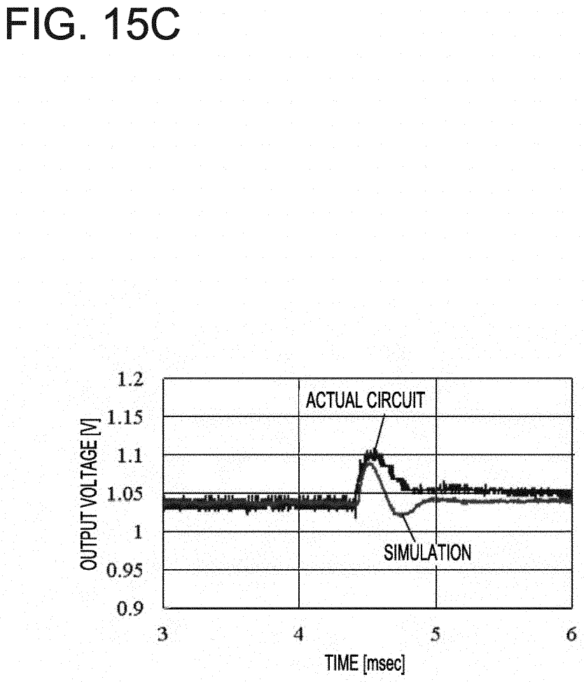

Each of FIGS. 15A to 15C is a view illustrating output voltage waveforms acquired in the simulation apparatus and the actual power supply circuit. FIG. 15A illustrates output voltage waveforms at the time of start-up, and FIGS. 15B and 15C illustrate output voltage waveforms at the time of load fluctuation (at the time of output current fluctuation). As illustrated in FIGS. 15A to 15C, in the simulation apparatus according to the embodiment of the present disclosure, it is possible to perform a real-time simulation of the switching power supply device that operates at a switching frequency of 100 kHz. Further, in the simulation apparatus according to the embodiment of the present disclosure, it is possible to obtain characteristics close to those of the actual power supply circuit. That is, it may be said that the characteristics of the actual power supply circuit may be reproduced.

In addition, the simulation apparatus 1 is an example of a simulation apparatus in the present disclosure. The power supply circuit 200 is an example of a power supply circuit in the present disclosure. The control MCU 4 is an example of a control device in the present disclosure. The PWM signal A1 is an example of a pulse signal in the present disclosure. The response output B1 is an example of a response output in the present disclosure. The input processor 10 is an example of an input processor in the present disclosure. The calculation unit 11 is an example of a calculation unit in the present disclosure. The output processor 13 is an example of an output processor in the present disclosure. The display processor 15 is an example of a display processor in the present disclosure. The first transfer function H₁(s) is an example of a first transfer function in the present disclosure. The second transfer function H₂(s) is an example of a second transfer function in the present disclosure. The third transfer function H₃(s) is an example of a third transfer function in the present disclosure. The first calculation unit 81 is an example of a first calculation unit in the present disclosure. The second calculation unit 82 is an example of a second calculation unit in the present disclosure. The third calculation unit 83 is an example of a third calculation unit in the present disclosure. The adding unit 84 is an example of an adding unit in the present disclosure. The reference voltage generating circuit 90 is an example of a reference voltage generating circuit in the present disclosure. The low pass filter 34 is an example of a first low pass filter in the present disclosure. The low pass filter 35 is an example of a second low pass filter in the present disclosure. The transmission processor 12 is an example of a transmission processor in the present disclosure. The transfer function deriving unit 14 is an example of a transfer function deriving unit in the present disclosure. The display device 55 is an example of a display device in the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A simulation apparatus of a power supply circuit, the simulation apparatus comprising:
an input processing circuit configured to process a pulse signal output from a control device that controls the power supply circuit;
a memory;
a processor coupled to the memory and configured to:
derive a response signal with respect to the pulse signal processed by the input processing circuit, by a calculation using a plurality of transfer functions that represents characteristics of the power supply circuit, and
process the response signal to transmit to a device that displays the response signal; and
an output processing circuit configured to process the response signal to transmit to the control device.

2. The simulation apparatus according to claim 1,
wherein the plurality of transfer functions include:
a first transfer function that expresses a relationship between an input voltage input to the power supply circuit and an output voltage output from the power supply circuit,
a second transfer function that represents a relationship between an output current output from the power supply circuit and the output voltage, and
a third transfer function that represents a relationship between a duty of the pulse signal and the output voltage.

3. The simulation apparatus according to claim 2,
wherein the processor is configured to:
derive a first response signal with respect to a set value of the input voltage, by a calculation using the first transfer function,
derive a second response signal with respect to a set value of the output current, by a calculation using the second transfer function,
derive a third response signal with respect to the pulse signal processed by the input processing circuit, by a calculation using the third transfer function, and
add the first response signal, the second response signal, and the third response signal.

4. The simulation apparatus according to claim 2,
wherein the input processing circuit includes a first low pass filter that averages the pulse signal, and an analog digital converter that converts an output signal of the first low pass filter into a digital signal, and
wherein the output processing circuit includes a pulse signal generating circuit that converts the response signal into a pulse signal, and a second low pass filter that averages the pulse signal output from the pulse signal generating circuit.

5. The simulation apparatus according to claim 4,
wherein the processor is further configured to:
derive the first transfer function, the second transfer function, and the third transfer function by simulating the power supply circuit,
wherein the processor is configured to:
cause each of the first transfer function and the second transfer function to include a frequency characteristic of an inverse characteristic of the second low pass filter, and
cause the third transfer function to include a frequency characteristic of an inverse characteristic of the first low pass filter and the frequency characteristic of the inverse characteristic of the second low pass filter.

6. The simulation apparatus according to claim 1, further comprising:
a reference voltage generator configured to generate a reference voltage commonly used for the control device, the input processing circuit, and the output processing circuit.

7. The simulation apparatus according to claim 1,
wherein the processor is configured to include:
a first processor to derive the response signal with respect to the pulse signal processed by the input processing circuit, by a calculation using a plurality of transfer functions that represents characteristics of the power supply circuit, and
a second processor to process the response signal to transmit to the device that displays the response signal.

8. The simulation apparatus according to claim 1,
wherein the processor is further configured to:
perform a processing of displaying an output voltage waveform that is time transition of an output voltage as the response signal, on a display screen of a display device.

9. The simulation apparatus according to claim 4,
wherein the input processing circuit includes a first level shifter that shifts a level of the pulse signal, and
wherein the output processing circuit includes a second level shifter that shifts a level of an output signal of the second low pass filter.

10. A computer-readable non-transitory recording medium having stored therein a program that causes a computer to execute a procedure, the procedure comprising:
deriving a response signal with respect to a first pulse signal to which a second pulse signal output from a control device that controls a power supply circuit is processed, by a calculation using a plurality of transfer functions that represents characteristics of the power supply circuit; and
processing the response signal to transmit to the control device, and to transmit to a device that displays the response signal.

11. The computer-readable non-transitory recording medium according to claim 10,
wherein the plurality of transfer functions include:
a first transfer function that expresses a relationship between an input voltage input to the power supply circuit and an output voltage output from the power supply circuit,
a second transfer function that represents a relationship between an output current output from the power supply circuit and the output voltage, and
a third transfer function that represents a relationship between a duty of the pulse signal and the output voltage.
